(19) United States
(12) Patent Application Publication
(10) Pub. No.: US 2005/0245626 A1
(43) Pub. Date: Nov. 3, 2005

(54) Polymer foaming using metal oxide particles

(76) Inventors: Todd Hoaglund, Greenfield, IN (US); Kenneth Cornelison, Richmond, IN (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/105,648

(22) Filed: Apr. 14, 2005

Related U.S. Application Data
(60) Provisional application No. 60/562,950, filed on Apr. 16, 2004.

(51) Int. Cl. C08K 3/00

(52) U.S. Cl. 521/91

(57) ABSTRACT

Systems and methods for forming foamed thermoplastic polymer articles by adding metal oxide, particularly silica provided as a part of glass, to the polymer prior to extrusion of the polymer. The metal oxide may be added to particulate polymer prior to melting or to a polymer melt prior to extrusion. At least some of the metal oxide will remain in the resultant foamed polymer article produced.

### CROSS REFERENCE TO RELATED APPLICATION(S)

This application claims the benefit of U.S. Provisional Patent Application Ser. No: 60/562,950 filed Apr. 16, 2004, the entire disclosure of which is herein incorporated by reference.

### BACKGROUND

1. FIELD OF THE INVENTION

This disclosure relates to systems and methods of foaming a polymer, especially a fluoropolymer, so as to produce a foamed article. In particular, the present invention relates to the mixing of metal oxide particles with the polymer prior to extrusion as an aid to foaming or as a foaming agent.

2. DESCRIPTION OF THE RELATED ART

Foamed articles and in particular foamed polymer articles are well known in the art and have many applications. Polymer foams are used, for example, for cushioning, insulation (thermal as well as sound), protection (packaging), weight reduction, impact absorption and thermal, chemical and electrical inertness, and may be used in a variety of products including, but not limited to, wires or cables, where they are used as insulation, coatings, tubes, films, and the like. Foamed polymer articles are typically produced from thermosetting foams, thermoplastic foams or elastomeric foams, and can be made using expanded beads or conventional polymer processing techniques like extrusion, injection molding, reactive injection and mechanical blending.

Forming a foam using extrusion was typically performed using a process whereby the polymer is melted in an extruder with a gas being injected during the extrusion process. Alternatively a chemical, specifically, a chemical compound that produces a gas upon decomposition, is added to generate the gas during the melt. In this situation, the extrusion process results in the decomposition of the compound to a gas. The gas or gas source is generally termed a blowing agent. The molten thermoplastic polymer is extruded through a die to form a foamed structure by having the gas become trapped in the polymer during the extrusion process. The process wherein a gas is used to foam the thermoplastic polymer is called physical foaming, whereas the process wherein a chemical compound that decomposes to produce the blowing agent is used and is called chemical foam blowing. In addition to the blowing agent, nucleating agents may be added to the molten polymer so as to improve the pore size and the homogeneity of the resulting foam.

Many different thermoplastic polymers can be used to produce foamed polymer articles such as polypropylene, polyethylene and polyester. Foamed polymer articles produced from thermoplastic melt-processable fluoropolymers specifically, polymers that have a partially or fully fluorinated backbone have also been produced. Such foamed fluoropolymers are of interest because of their superior heat resistance, chemical inertness, incombustibility, good dielectric properties, and, in particular, electrical insulating properties. For example, a foamed copolymer of tetrafluoroethylene and hexafluoropropylene, known as FEP, is particularly suitable for insulation of electrical wires such as data communication cables and coaxial cables because of the low dielectric constant and low dissipation factor associated with such foamed FEP polymers.

Disadvantages of the processes utilizing gas for foam are that special equipment is needed to inject the gas when physical foaming is employed. When chemical foaming is used, the chemical foaming agent used must decompose to a gas during extrusion and may cause colored decomposition compounds to be formed or may chemically react with the polymer to be foamed during the process. Also, in order to produce foams of small cell size and of high homogeneity, nucleating agents need to be added to the composition, which may make the manufacturing more costly and less convenient.

### SUMMARY

Because of these and other problems in the art, described herein, among other things, are systems and methods for adding a metal oxide, particularly silicon dioxide (silica), to a polymer prior to extrusion to produce foaming. The metal oxide may be provided alone or in combination with known blowing agents and may be mechanically mixed with polymer pellets prior to melt or added to melted polymer. Articles made using these systems and methods generally show improved dielectric properties making them particularly suitable for use in cable insulation applications.

Described herein, in an embodiment, is a method for foaming a thermoplastic polymer comprising the steps of: providing pellets of a thermoplastic polymer; mechanically mixing metal oxide particles with said thermoplastic polymer pellets to form a mixture; heating said mixture so as to melt said thermoplastic polymer pellets but not said metal oxide particles, said heating resulting in the formation of a melt mixture; extruding said melt mixture; and allowing said extruded melt mixture to harden, said hardened mixture comprising a plastic foam.

In an embodiment of the method the metal oxide is non-ionic and of the form XₐO_{b} where X represents an elemental metal atom and a and b are whole numbers, this may include, but is not limited to, a metal oxide comprising silica (SiO₂), which may be a part of glass in any shape including, but not limited to, spherules or hollow microspheres.

In an embodiment, the thermoplastic polymer comprises a fluoropolymer such as but not limited, to FEP. In another embodiment the method further includes the step of: adding a blowing agent to said melt mixture.

In another embodiment, there is described a method for foaming a thermoplastic polymer comprising the steps of: providing a thermoplastic polymer; melting said thermoplastic polymer; mixing a particulate metal oxide with said melted thermoplastic polymer to form a melt mixture; extruding said melt mixture; and allowing said extruded melt mixture to harden, said hardened mixture comprising a plastic foam.

In another embodiment of this second method the metal oxide is non-ionic and of the form XₐO_{b} where X represents an elemental metal atom and a and b are whole numbers, this may include, but is not limited to, a metal oxide comprising silica (SiO₂), which may be a part of glass in any shape including, but not limited to, spherules or hollow microspheres.

In another embodiment of this second method, the thermoplastic polymer comprises a fluoropolymer such as but not limited, to FEP. In another embodiment this method further includes the step of: adding a blowing agent to said melt mixture.

In a still further embodiment, there is described an extruded thermoplastic polymer article comprising a thermoplastic foam including voids; and a plurality of glass spherules; wherein the volume of at least some of said voids is, at least in part, the result of the addition of said glass spherules prior to the extrusion of said thermoplastic polymer. In another embodiment, the object comprises electrical insulation media extruded onto a conductor.

### BRIEF DESCRIPTION OF THE DRAWINGS

FIG. 1 shows a drawing of cable having a foamed polymer including glass microspheres as an insulator.

FIG. 2 shows a drawing of extruded FEP foam including silica particles used in the foaming.

### DESCRIPTION OF PREFERRED EMBODIMENT(S)

In an embodiment, a thermoplastic, particularly a polymer such as a fluoropolymer, can be foamed during extrusion by adding thereto metal oxide particles, preferably non-ionic metal oxide particles, and extruding the polymer in extrusion equipment, or otherwise thermally processing it to form a desired shape. The metal oxide particles will generally be blended with the cold polymer prior to heating for extrusion by mechanical mixing of the raw polymer pellets, with particles of metal oxide. The metal oxide particles should be mixed with the polymer pellets for a time and to an extent sufficient to distribute them throughout the polymer pellets and provide a product capable of foaming in a relatively uniform manner. This mixture will then be processed, generally by extrusion, by heating the mixture to a desired temperature so as to obtain a molten polymer having blended therein the metal oxide particles. As this molten composition leaves the processing equipment, e.g., the extrusion die, the composition foams and this foam is thereafter cooled and hardened to form the final foamed product.

While the above refers to polymer pellets as the form of the polymer prior to melting, it should be recognized that the use of that term is not intended to refer to any particular shape or size of the raw polymer prior to processing. The term pellets or pelletized, as used herein, is intended to simply mean that the polymer is generally provided in a form comprising recognizable pieces, whether those pieces comprise granules or other powder forms; grown crystalline forms; pellets, bales, composites or other compaction or adhered forms; shreds, cutoffs or other torn down or scrap forms; spherules or other formed shapes; or any other form. The term pelletized is used simply to identify that there are a plurality of pieces present that together with the particles of metal oxide can be combined into a mixture. In the same way, the term particles or particulate when referring to the metal oxide does not require the material to be in a powder form, but may instead be in pieces in any of the forms discussed above in the description of a pellet form. However, the metal oxide pieces will generally, but are not required to, be smaller than the polymer pieces.

It should be recognized that while this disclosure discusses particles, pellets, or pieces of the metal oxide or polymer, it is not required that the metal oxide or polymer be in a physically solid form in those pieces, some metal oxides, such as silica, are accepted as being able to be separated into pieces even when in a highly viscous liquid form such as, but not limited to, a glassy form. Further, the metal oxide need not be pure and may be provided in an impure form, for instance silica may be provided as part of glass, such as by using glass microspheres as the foaming agent. Further a non-ionic form of the metal oxide may include ionic forms as impurities.

In another embodiment, instead of adding the metal oxide particles to the solid polymer pellets prior to melt, the metal oxide particles may also be distributed into the already melted polymer which is then extruded. The metal oxide may be used alone as a sole foaming agent or may be used in addition to the inclusion of a known blowing agent such as, but not limited to, nitrogen gas. Such blowing agent may be of any type and added in any manner known to those of ordinary skill in the art.

The metal oxide particles for use in these methods and for the resulting objects include a wide variety of chemical formulations and physical characteristics. A preferred metal oxide is silicon dioxide (also known as silica or SiO₂). Silica may be used in a variety of physical forms including, but not limited to, fine grained powders, such as those produced under the name CAB-O-SIL and manufactured by Cabot Corporation, microcrystals, or small formed shapes. While grains and similar structures may be used, uniform formed shapes such as spherules are preferred. A preferred form of silica is in the form of glass microspheres, particularly hollow glass microspheres. While silica is used in a preferred embodiment, there are many metal oxides of various chemical formulations and physical forms that may be used in other embodiments. Generally, binary metal oxides having the generic chemical formula XₐO_{b}, wherein X represents an elemental metal atom, 0 is an oxygen atom and a and b are both whole numbers representing the molar ratio of X/O in the metal oxide are preferred. These metal oxides are also preferred to be in a non-ionic form. Many examples of such binary metal oxides exist and may be used in embodiments of this invention, including MgO, CaO, Al₂O₃, GeO₂, Fe₂O₃, ZrO₂, SnO₂, ZnO, and many others.

It should be recognized that the metal oxide particles, while they may result in the generation of some gas (as discussed later), do not, in many respects, act in the same manner as traditional chemical blowing agents which decompose during the extrusion process to produce a gas. Since the metal oxides may not break down during the foaming process, a significant portion of the original solid metal oxide particles will remain in the polymer foam throughout the foaming process and after extrusion. In a preferred embodiment, the resultant foamed polymer therefore still includes most if not all the original metal oxide particles in addition to foam “voids”. The metal oxide particles are generally not completely consumed during extrusion. The resultant foamed polymer, therefore will generally include metal oxide particles.

A foamed polymer produced using metal oxide particles, in an embodiment, can be reintroduced into the extrusion equipment, and will produce a foam again without adding new or additional metal oxide particles as the original particles are still present in the resultant foam. Such a re-foaming process is normally not possible with known processes using chemical foaming agents because in the known processes the chemical foaming agent will have been consumed (decomposed to gas) during the original foaming process and therefore the decomposition necessary to produce the gas blowing agent cannot occur when the product is re-melted and re-extruded. The re-foaming capability of foamed polymers including metal oxide particles provides foamed polymer waste that can be conveniently recycled and used again to produce similarly foamed articles without the need for additional metal oxide. Furthermore, metal oxide particles are inorganic and substantially inert, and so can be used in foamed articles designed for operation in high temperature environments without the risk of decomposition.

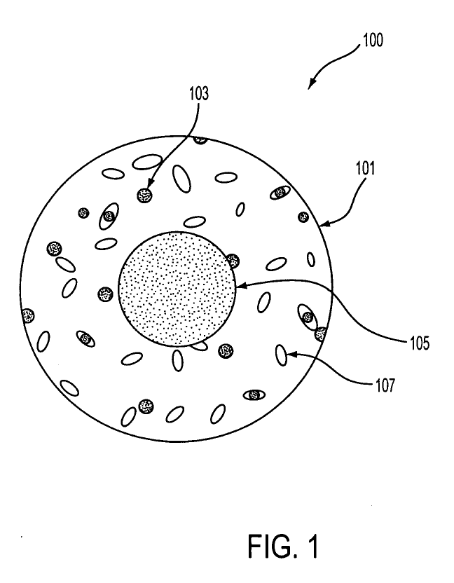

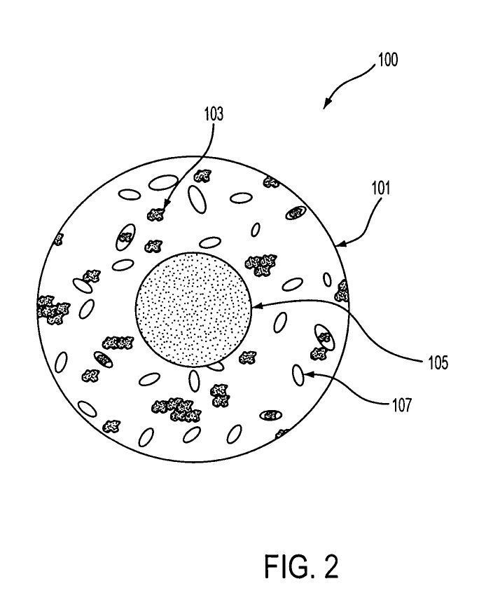

The foamed articles produced with the method of the invention may have highly desirable properties. These properties can arise both from the foaming action and from the continued presence of metal oxide in the resultant foamed article. For example, foamed fluoropolymers produced with the method of the invention may have excellent dielectric properties, in particular a low dielectric constant and a low loss factor or dissipation factor making such foamed fluoropolymers particularly suitable as insulating medium in, for example, wires and data communication cables, such as plenum wires, high frequency cables, and coaxial cables. An embodiment of a cable (100) utilizing a foamed polymer (101) having voids (107) and including metal oxide particles (103) as an insulator for a conductor (105) is shown in FIGS. 1 and 2. Additionally, the foamed articles may find application as piezoelectric substrates or in tubes. Further, due to the inherent properties of metal oxides, particularly when in the form of hollow spheres, the inclusion of the metal oxide itself, in addition to the foaming effect, can further improve dielectric properties. This is the embodiment shown in FIG. 1 where the metal oxide particles (103) comprise hollow glass microspheres. The Embodiment of FIG. 2 shows a similar cable except the particles (103) are granular and have clumped together more than in the embodiment of FIG. 1.

Metal oxide particles can be used on their own as a foaming agent without the addition of a gas or a chemical foaming agent designed to produce a gas (blowing agent) in a process that creates a foamed thermoplastic, melt-processable polymer. In this embodiment, the manufacture of foamed articles is dramatically simplified as there is no need to introduce the blowing agent. In an embodiment, the manufacturing is significantly simplified because the metal oxide can be added in a particulate form to pelletized polymer. The mixture of polymer and metal oxide can also be made by mechanical mixing which uses fairly straightforward technology.

Although the metal oxide particles on their own are suitable for foaming a polymer, in an embodiment, metal oxide in mixture with the polymer may be used in conjunction with other foaming agents, such as for example a physical foaming agent such as nitrogen gas, or a chemical foaming agent. Although in such an embodiment the convenience of manufacturing that is otherwise obtained by not using other foaming agents may be minimized, the metal oxide particles still provide the advantage of producing a foamed article with particularly good characteristics such as, for example, its dielectric properties, which may otherwise not be obtained. Also, the addition of metal oxide particles to the polymer composition to be foamed may allow the extrusion and foaming of the polymer to be run at a higher speed as it has also been observed that the particles of metal oxide improve the flow characteristic of the polymer, thereby reducing the manufacturing cost. The resultant foamed polymer will also still include metal oxide particles providing for recyclability and the specific improved dielectric properties from their inclusion.

In an embodiment, the inclusion of the metal oxide particles is performed by generating a simple mechanical mixture of polymer pellets and metal oxide particles. Particles of the metal oxide in an embodiment, are dry blended with the polymer pellets or, in an alternative embodiment, are blended directly into the polymer melt and upon extrusion of the polymer and metal oxide composition the polymer will foam to a degree dependent upon various factors, including the amount of metal oxide particles present, the temperature of extrusion, and the dwell time during processing. Some specific results from changing these factors are discussed in the examples. Accordingly, the foaming of the polymer can be carried out on conventional extrusion equipment.

The amount of metal oxide particles used to foam any particular polymer depends, at least in part, on the degree of foaming that is desired. Typically, at least 0.3% volume to volume of metal oxide in polymer will be used to provide a recognizable foam. It has been found that to produce foams with particularly valuable properties for use as wire or cable insulation, at least 0.5% by volume of the metal oxide should be used to produce a foam, more preferably at least 1% by volume is used. Foams produced according to these percentages show particularly improved dielectric properties over foams produced from a more traditional blowing agent. The maximum amount of metal oxide particles to be included in the polymer is subject to various factors, including economic considerations, as well as considerations as to the desired properties of the foamed polymer article. The maximum amount of metal oxide particles that is included with the polymer will rarely exceed 15% by volume due to cost considerations, although, in alternate embodiments, any amount of metal oxide can be used.

The polymers used in an embodiment include polymers that are thermoplastic and melt-processable. By the term thermoplastic is meant that the polymers can be melted upon heating and solidify again upon cooling. By melt-processable is meant that the melted polymer should have a melt viscosity low enough such that it can be processed through melt extrusion equipment. Polymers with these two characteristics are easily processed by extrusion. Some polymers that may be suitable for use include polyolefin polymers such as polyethylene and polypropylene as well as other thermoplastic polymers such as polyesters. Co-polymers including two or more different polymers may also be used.

Fluoropolymers are particularly useful in applications related to insulations for wire and cable due to their already desirable properties. A fluoropolymer generally means a polymer that has a partially or fully fluorinated backbone. Particularly preferred fluoropolymers for wire and cable applications are those that have a backbone that is at least 30% by weight fluorinated, preferably at least 50% by weight fluorinated, more preferably at least 70% by weight fluorinated, and most preferably polymers that have a fully fluorinated backbone. Polymers that have a fully fluorinated backbone are sometimes known as perfluorinated polymers. Fluoropolymers in an embodiment may include one or more fluorinated monomers optionally co-polymerized with one or more non-fluorinated monomers. Examples of fluorinated monomers include fluorinated olefins such as tetrafluoroethylene, chlorotrifluoroethylene, vinyl fluoride, vinylidene fluoride, and fluorinated alkyl vinyl monomers such as hexafluoropropylene; fluorinated vinyl ethers, including perfluorinated vinyl ethers and fluorinated allyl ethers including perfluorinated allyl ethers. Suitable non-fluorinated co-monomers include vinyl chloride, vinylidene chloride, and C₂ to C₈ olefins such as ethylene and propylene. Typically, the thermoplastic, melt-processable fluoropolymers for use in this invention will have a melting point of 50C to 310C to provide for ease of processing.

Some particular examples of fluoropolymers used in embodiments for generating foamed insulations for wire and cable include homopolymers of tetrafluoroethylene; copolymers of tetrafluoroethylene or chlorotrifluoroethylene, and ethylene; copolymers of tetrafluoroethylene and hexafluoropropylene; copolymers of tetrafluoroethylene, vinylidene fluoride, and hexafluoropropylene; copolymers of tetrafluoroethylene or chlorotrifluoroethylene, ethylene and a perfluorovinyl ether; and copolymers of tetrafluoroethylene and a perfluorovinyl ether.

The composition of polymer and metal oxide, in an embodiment, may comprise still further additives such as nucleating agents. Nucleating agents are typically compounds that help control the cell size of the foam and generally result in a more homogeneous cell size and are understood by those of ordinary skill in the art. A commonly employed nucleating agent is boron nitride or a combination thereof with certain inorganic salts as disclosed in U.S. Pat. No. 4,764,538 the entire disclosure of which is hereby incorporated by reference. Other nucleating agents that can be used include the sulphonic or phosphonic acids and salts thereof as disclosed in U.S. Pat. No. 4,877,815 the entire disclosure of which is herein incorporated by reference.

While the invention should not be understood to be limited by the following theories of action, and additional alternative mechanisms of action may be occurring other than those herein explained, several theories exist as to how metal oxide particles act to aid in foaming or as a foaming agent. A first theory describes the action of the metal oxide particles as that of nucleating agents, providing a nucleation site for gas bubble formation. Under this theory, the gas that forms during extrusion and is the blowing agent is hydrogen fluoride (HF), which is released during normal extrusion processing of fluoropolymers, and is released in increasing amounts as the processing temperature increases.

A second theory, which may be broadly applicable by analogy, relies on the well-known chemical reaction between silica and HF: SiO₂ (s)+4HF (g)→SiF₄ (g)+2H₂O. At processing temperatures of 600° F., such as used in the examples below, water from this reunion readily vaporizes to the gaseous state thereby creating the voids in the extruded polymer in addition to what would be created with only SiF₄ (g). It is possible that both these mechanisms are at work and that additional or alternative mechanisms create the foaming observed.

The foamed polymer articles produced in an embodiment preferably will have an average cell size for closed cells of not more than 100 μm, more preferably not more than 50 μm. Such foamed polymer articles can be readily produced with the present invention by selecting metal oxide particles having particular characteristics and selecting the amounts thereof. The foaming degree of the foamed polymer will typically be between 5% and 70%, preferably between 20% and 50%. The desired foaming degree can be conveniently obtained by selecting the appropriate amount of metal oxide particles or combining the metal oxide particles and a chemical or physical foaming agent, such as, for example, nitrogen gas as a combination foaming agent.

The foamed polymer article that can be obtained with this invention can be used in any of the applications in which foamed articles are used. For example, the foamed article may be a film, a tube, or a hose. Also, foamed polymers such as for example foamed polyolefin polymers can be formed into piezoelectric substrates as described in, for example, the Journal of Applied Physics, vol. 89, no. 8, pp. 4503-11 (2001), the entire disclosure of which is herein incorporated by reference. Additionally, the foamed polymers, in particular the foamed fluoropolymers produced with this invention find desirable application as electrical insulation media, in particular, for the insulation of electrical cables. Such electrical cables include data communication cables that operate at high frequency of, for example, 100 kHz to 40 GigaHz. The cables may be, for example, coax cables or so called twisted pair cables.

The invention is further illustrated by the following examples. These examples merely illustrate the merits of the invention and they should not be taken to limit the invention in any way.

### EXAMPLES

### Example 1

Varying Volumes of Hollow Glass Spheres in FEP

In this example, mixtures of hollow glass spheres in FEP were extruded onto wire. The extrusion produced an 8 mil wall over a .0211 copper conductor. The example used a 1.25″, 24:1 extruder. FEP and glass sphere characteristics are shown in the following tables.

FEP

| Specific Gravity | 2.14 +/− .02 g/cc |
|---|---|
| Melt Flow Rate | 30.5 +/− 2.5 GMS/10 |
| Tensile | 3000 PSI Nom. |
| Elongation | 300% Nom. |
| Dielectric Constant | 2.03 |

Glass Microspheres

| | | |
|---|---|---|
| Particle Size | 0.030 | mm |
| Density | 0.60 | g/cc |
| N₂ isostatic crush strength | 18,000 | psi |

| | |
|---|---|
| Dielectric Constant | 1.2 to 2.0 @ 100 MHz |

The results of this example are shown in the following table.

| | | FEP + 5% (v/v) | FEP + 10% (v/v) |
|---|---|---|---|
| | FEP | glass beads | glass beads |
| Tensile (psi) | 3500 | 2700 | 2000 |
| Elongation (%) | 470 | 420 | 300 |
| Material | 0 | 7 | 20 |
| Displacement (%) | | | |
| Impedance (ohm) | 104 | 103 | 99 |

As expected with the addition of glass beads, tensile strength and elongation values decreased with increasing amounts of glass beads in the polymer composition. The unexpected benefit is obtained in the material displacement, which is significantly above what is expected indicating the occurrence of foaming.

### Example 2

Varying Melt Temperatures for Hollow Glass Spheres in FEP

Using the same materials and equipment as used in example 1 above, a composition of 5% (v/v) glass beads in FEP was extruded in several trials. From trial to trial the melt temperature was varied by changing the heat profile of the extruder. The trials in this example were aimed at determining the effect of temperature on foaming when using glass beads as a foaming agent. In these experiments the extruder speed (RPM) was maintained at a constant value. As can be seen in the results shown in the table below, increasing temperature led to significantly increased foaming, as is indicated by both the increasing material displacement and the increasing line speed.

| | Sample | | | |
|---|---|---|---|---|
| | 1 | 2 | 3 | 4 |
| Melt | 610 | 640 | 680 | 710 |
| Temperature (° F.) | | | | |
| Line Speed | 245 | 258 | 280 | 377 |
| (fpm) | | | | |
| Head Pressure | 1000 | 850 | 700 | 530 |
| (psi) | | | | |
| Material | 7 | 12 | 20 | 40 |
| Displacement | | | | |
| (%) | | | | |

Material Displacement was calculated using the specific gravity of the FEP/glass bead composition and measured physical dimensions and measured weight of the extruded foamed polymer.

### Example 3

Fumed Silica Particles in FEP

For this example, fumed silica having the following properties was used as the blowing agent.

CAB-O-SIL Fumed Silica

| | | |
|---|---|---|
| Particle Size | 0.2-0.3 | microns |
| Bulk Density | 3.0 | lb/ft³ max |
| Specific Gravity | 2.2 | g/cc |

A composition of 1% by weight of CAB-O-SIL fumed silica in FEP was prepared before the composition was added to the single screw extruder hopper. A solid rod was extruded out of a 0.200″ die. The silica did not mix uniformly with the FEP, but tended to clump together as shown in FIG. 2.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A method for foaming a thermoplastic polymer comprising the steps of:
providing pellets of a thermoplastic polymer;
mechanically mixing metal oxide particles with said thermoplastic polymer pellets to form a mixture;
heating said mixture so as to melt said thermoplastic polymer pellets but not said metal oxide particles, said heating resulting in the formation of a melt mixture;
extruding said melt mixture; and
allowing said extruded melt mixture to harden, said hardened mixture comprising a plastic foam.

2. The method of claim 1 wherein said metal oxide is non-ionic and of the form XₐO_{b} where X represents an elemental metal atom and a and b are whole numbers.

3. The method of claim 2 wherein said metal oxide comprises silica (SiO₂).

4. The method of claim 3 wherein said silica is provided as part of glass.

5. The method of claim 4 wherein said metal oxide particles comprise glass spherules.

6. The method of claim 5 wherein said glass spherules are hollow glass microspheres.

7. The method of claim 1 wherein said thermoplastic polymer comprises a fluoropolymer.

8. The method of claim 7 wherein said fluoropolymer comprises FEP.

9. The method of claim 1 further comprising the step of: adding a blowing agent to said melt mixture.

10. A method for foaming a thermoplastic polymer comprising the steps of:
providing a thermoplastic polymer;
melting said thermoplastic polymer;
mixing a particulate metal oxide with said melted thermoplastic polymer to form a melt mixture;
extruding said melt mixture; and
allowing said extruded melt mixture to harden, said hardened mixture comprising a plastic foam.

11. The method of claim 10 wherein said metal oxide is non-ionic and of the form XₐO_{b} where X represents an elemental metal atom and a and b are whole numbers.

12. The method of claim 11 wherein said metal oxide comprises silica (SiO₂).

13. The method of claim 12 wherein said silica is provided as part of glass.

14. The method of claim 13 wherein said metal oxide particles comprises glass spherules.

15. The method of claim 14 wherein said glass spherules are hollow glass microspheres.

16. The method of claim 10 wherein said thermoplastic polymer comprises fluoropolymer.

17. The method of claim 16 wherein said fluoropolymer comprises FEP.

18. The method of claim 10 further comprising the step of: adding a blowing agent to said melt mixture.

19. An extruded thermoplastic polymer article comprising
a thermoplastic foam including voids; and
a plurality of glass spherules;
wherein the volume of at least some of said voids is, at least in part, the result of the addition of said glass spherules prior to the extrusion of said thermoplastic polymer.

20. The article of claim 19 wherein said object comprises electrical insulation media extruded onto a conductor.
